(19) United States
(12) Patent Application Publication
(10) Pub. No.: US 2006/0265278 A1
(43) Pub. Date: Nov. 23, 2006

(54) System and method for censoring randomly generated character strings

(75) Inventor: Matthew J. DiMeo, La Jolla, CA (US)

Correspondence Address: DARBY & DARBY P.C., P. O. BOX 5257, NEW YORK, NY, 10150-5257, US

(73) Assignee: Napster LLC, New York, NY (US)

(21) Appl. No.: 11/132,752

(22) Filed: May 18, 2005

(51) Int. Cl. G06Q 30/00; H04L 9/00

(52) U.S. Cl. 705/14; 380/268

(57) ABSTRACT

A method for generating a random string of characters can include the steps of determining a full character set. A full character set can include letters (both upper and lower case), digits, and other characters. Embodiments of a full character set are: the alphabet of one language, adding digits, and multiple alphabets. The method can reduce the full character set to a reduced character set. Reducing the full character set can include one or a number of steps, including removing at least one vowel from the full character set, removing at least one digit from the full character set, removing at least one letter from the full character set based on frequency of use, removing at least one digraph and/or. The random string of characters can be generated using the reduced character set. The random string of characters can be converted to a promotional code.

### FIELD OF THE INVENTION

The present invention relates to a random code generation system that censors the randomly generated string of characters by removing one or more letters or digits.

### BACKGROUND OF THE INVENTION

Virtual retailers, like their brick and mortar counterparts, use promotional gifts and identify certain groups for particular discounts. The brick and mortar retailer can use coupons, certificates, and gift cards that can be redeemed at the time of purchase. The coupons, certificates, and gift cards are in physical form and can be verified by the cashier at the time of purchase. Virtual retailers, e.g., web based, cannot use physical media for their promotions, since they cannot validate physical media on-line. Instead, virtual retailers use special codes that can be entered at the time of transaction to identify that the transaction is promotional based or entitled to a discount. Promotional codes can be for discounts, identifying particular groups of customers, and to use a “gift card”, a credit on an account that may have been purchased in advance for the user. Promotional codes can also be considered one or both of a user name and password given to a user for a complimentary or “trial period” account.

Typical promotional codes are randomly generated strings of characters of a particular length. Given the fixed number of letters in any alphabet (for example, the English alphabet consists of 26 letters) and digits (e.g., 0-9) and the large number of randomly generated promotional codes, there is a significant probability that the randomly generated string is a word or approximates a word in the native language. A problem is that the randomly generated “word” may be rude, profane or trademarked and thus improper to release to the user.

Prior art systems keep a “scrub list” to prevent improper promotional codes from reaching the user. The scrub list is a database of all of the character strings and words that the provider considers improper to release to a user. The list is usually labor intensive to build because the provider must enter every word he wants to remove and any close variant. For example, if an improper word contains an “o” the provider should also add a character string containing a “0” (zero) since the “o” and “0” are visually similar. Further, there are a number of words that have slang meanings that may also be improper. A difficulty with slang terms is that the slang use may be regional and the provider, being in a separate region, may not know of the slang use until after a user complains. Further, words enter common usage that the provider may consider improper or new trademarks are used or registered and the provider needs to constantly update the scrub list.

Furthermore, once the scrub list is created and updated, it is processor intensive to continuously monitor the generated promotional codes. Every code generated must be compared to every entry in the scrub list to determine if there is a match. If a promotional code matches a string on the scrub list, the promotional code must be deleted, a new one generated and the new promotional code compared to the scrub list. This can cause an unacceptable delay in providing the promotional code to the user.

Thus, there is a need in the art for a way to censor randomly generated strings of characters without comparison to a scrub list and that is not processor intensive.

### SUMMARY OF THE INVENTION

A method for generating a random string of characters can include the steps of determining a full character set. A full character set can include letters (both upper and lower case), digits, and other characters. In an embodiment, the full character set is an alphabet of one language, e.g., English (A-Z). Other embodiments include adding digits, e.g., the Arabic numerals (0-9). Further embodiments can use multiple alphabets, e.g., English and Greek.

The method can reduce the full character set to a reduced character set. Reducing the full character set can include one or a number of steps. One step can be removing at least one vowel from the full character set. In the English language, the vowels are A, E, I, O, U and can also include Y. Removing the vowels prevents many strings of characters from forming words. Almost every word in the English language requires at least one vowel and without them, the strings of characters most likely cannot form a recognizable word.

Another step can be to remove at least one digit from the full character set or to remove at least one letter from the full character set based on frequency of use of the letter in the language based on the full character set. Letter frequency can be chosen depending on the nature of the users receiving the promotional code or a decision of the provider or system. Any number of letters can be selected. Further, at least one digraph can be removed from the full character set. Optionally, at least one trigraph can be removed from the full character set.

The random string of characters can be generated using the reduced character set. The random string has a very high probability that the collection of characters do not form a word. A number of factors go into the above steps. Factors like number of characters in the reduced character set and number of characters in the random string directly affect how many unique combinations of character strings that can be generated. The largest number of unique random strings is generated when each character is chosen at random. A lesser number of unique combinations are available if there is a limitation on duplicates or what characters can or cannot be in proximity.

Another embodiment is a method for generating a promotional code which includes the steps of receiving a request from a user for the promotional code. The user is typically on a user device, which can be a computer, PDA, cellular telephone, or any other networked device, networked to a provider's system, e.g., a server. The network can be a LAN, WAN, Internet or a cellular telephone network. The provider's system can generate a random string of characters using a reduced character set. The random string of characters can be converted to the promotional code and provided to the user.

Converting the random string of characters to the promotional code can include saving the random string of characters to a database that can save and track information necessary to complete a commercial transaction with the promotional code. In another embodiment, the user device can run a client system for the provider's system. The client can generate the random string of characters and pass the string to the provider's system, over the network, and the provider's system convert the string to the promotional code.

In a further embodiment, generating a promotional code can include the step of creating the reduced character set, having the steps of determining a full character set and reducing the full character set to the reduced character set. Reducing the full character set to the reduced character set can include the same steps as above. Furthermore, an embodiment includes using the English alphabet and Arabic numeral system and removing all vowels from the full character set and removing at least one digit from the full character set wherein the at least one digit is “0” and “1”.

The promotional code is generated at a generation date. Any method can be used to generate the promotional code, including the methods described above and any method known in the art. A promotional expiration date for the promotional code is set and a use of the promotional code is tracked. The use can have a related use expiration date. The provider's system converts the use expiration date to the promotional expiration date.

Further, the promotional expiration date can be set by adding a fixed time to the generation date. Alternately, the provider's system can receive an inputted time and add the inputted time to the generation date. Also, the promotional expiration date can be received from the user.

### BRIEF DESCRIPTION OF THE DRAWINGS

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

FIG. 1 is a diagram illustrating the character strings of the present invention;

FIG. 2 is a flow chart of a method of the present invention;

FIG. 3 is a diagram illustrating an embodiment of the system of the present invention;

FIG. 4 is a flow chart of another method embodiment of the present invention; and

FIG. 5 is a flow chart of a method of another embodiment of the present invention.

### DETAILED DESCRIPTION OF THE PREFERRED EMBODIMENTS

### DEFINITIONS

The terms used in this specification generally have their ordinary meanings in the art, within the context of this invention and in the specific context where each term is used. Certain terms are discussed below, or elsewhere in the specification, to provide additional guidance to the practitioner in describing the methods of the invention and how to make and how to use them. The scope and meaning of any use of a term will be apparent from the specific context in which the term is used.

The term “character” means a mark or symbol used in a writing system and contains letters and digits.

The term “letter” means a written symbol or character representing a speech sound and being a component of an alphabet.

The term “digit” means a symbol used in a system of numeration, for example, one of the ten Arabic number symbols, 0 through 9.

The term “alphabet” means a character set that includes letters and is used to write a language.

The term “vowel” means a letter representing a speech sound, such as (\overline{e}) or (\check{i}), created by the relatively free passage of breath through the larynx and oral cavity, usually forming the most prominent and central sound of a syllable. For example, a letter, such as a, e, i, o, u, and sometimes y in the English alphabet, represents a vowel.

The term “consonant” means a letter representing a speech sound produced by a partial or complete obstruction of the air stream by any of various constrictions of the speech organs, such as (p), (f), (r), (w), and (h).

The term “word” means a sound or a combination of sounds, or its representation in writing or printing, that symbolizes and communicates a meaning.

The term “diagraph” means a pair of letters representing a single speech sound, such as the ph in pheasant or the ea in beat.

The term “trigraph” means three letters spelling one consonant, vowel, or diphthong, such as Sch in Schiller or igh in high or thigh

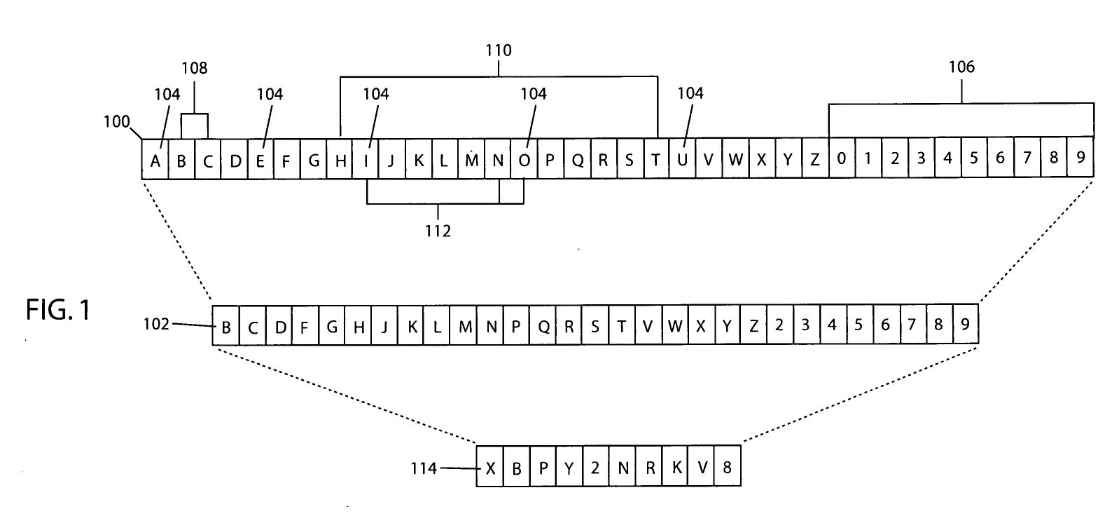

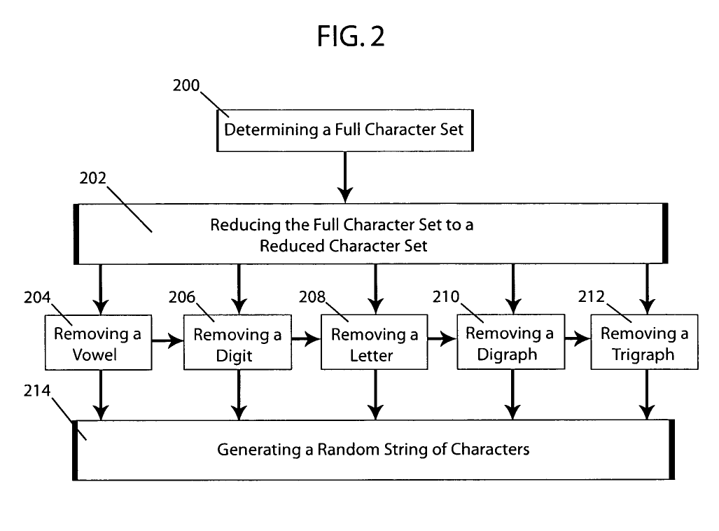

Referring now to FIGS. 1 and 2, a method of the present invention is illustrated. A method for generating a random string of characters can include the steps of determining a full character set 100 (step 200). A full character set can include letters, digits, and other characters. Examples of other characters are: punctuation (. , ? ; : !); typographical marks (“ ‘ @ # $ % &); and mathematical operators (+ − * /). In an embodiment, the full character set is an alphabet of one language, e.g., English (A-Z), and can include both upper and lower case letters. Other embodiments include adding digits, e.g., the Arabic numerals (0-9). Further embodiments can use multiple alphabets, e.g., English and Greek.

The method can reduce the full character set 100 to a reduced character set 102 (step 202). Reducing the full character set 100 can include one or a number of steps. One step can be removing at least one vowel 104 from the full character set 100 (step 204). In the English language, the vowels are A, E, I, O, U and can also include Y. Removing the vowels 104 prevents many strings of characters from forming words. Almost every word in the English language requires at least one vowel and without them, the strings of characters most likely cannot form a recognizable word.

Another step can be to remove at least one digit 106 from the full character set 100 (step 206). This is assuming that digits 106 are included in the full character set 100. Adding or removing digits 106, in and of its self typically does not prevent a character string from forming a word. However, certain digits, for example “0” and “1” are visually similar to “o” and “l” and removing them can reduce confusion and prevent an objectionable character string from being formed using, for example, “0” in place of “o”. In another embodiment, all vowels 104 and digits 106 “0” and “1” are removed to form the reduced character set 102.

Another option can be to remove at least one letter 108 from the full character set 100 based on frequency of use of the letter 108 in the language based on the full character set 100 (step 208). For example, there are numerous calculations for letter frequency and the letters are arranged from most frequent to least frequent.
Letter Frequency in the English Language: e t a o i n s r h l d c u m f p g w y b v k x j q z.
Letter Frequency in Press Reporting: e t a o n i s r h l d c m u f p g w y b v k j x q z.
Letter Frequency in Religious Writings: e t i a o n s r h l d c u m f p y w g b v k x j q z.
Letter Frequency in Scientific Writings: e t a i o n s r h l c d u m f p g y b w v k x q j z.
Letter Frequency in General Fiction: e t a o h n i s r d l u w m c g f y p v k x j x z q.
Letter Frequency in Word Averages: e t a o i n s r h l d c u m f p g w y b v k x j q z.
Letter Frequency in Morse Code: e t a i n o s h r d l c u m f w y g p b v k q j x z.
Letter Frequency using 18584 Common Base Words and no plural words or words with common suffixes: e a i r t o n s l c u p m d h g b y f v w k x z q j.
Letter Frequency using 45406 Common Words and plural words and words with common suffixes: e i s a r n t o l c d u g p m h b y f v k w z x j q.

Letter frequency can be chosen depending on the nature of the users receiving the promotional code or a decision of the provider or system. Any number of letters can be selected. For example, e t a o i n s h r d l u, according to one calculation, are the twelve most common letters in the English language. However, the letter ‘h’ appears more often in every day speech and writing than it does in a list of dictionary words.

Further, at least one digraph 110 can be removed from the full character set 100 (step 210). A digraph 110 is a pair of letters that form one sound and digraph frequency in the English Language is: th he an in er on re ed nd ha at en es of nt ea ti to io le is ou ar as de rt ve. Optionally, at least one trigraph 112 can be removed from the full character set (step 212). Trigraph Frequency in the English Language: the and tha ent ion tio for nde has nce tis oft men.

The random string of characters 114 can be generated using the reduced character set 102 (step 214). The random string 114 has a very high probability that the collection of characters do not form a word. A number of factors go into the above steps. Factors like number of characters in the reduced character set 102 and number of characters in the random string 114 directly affect how many unique combinations of character strings that can be generated. The largest number of unique random strings 114 is generated when each character is chosen at random. A lesser number of unique combinations are available if there is a limitation on duplicates or what characters can or cannot be in proximity.

The number of unique combinations, based on a specific number of characters, for the random character string 114 is reduced as more characters are removed from the full character set 100. The number of combinations can be increased by increasing the number of characters generated in the random string 114.

For example, if the full character set is the English alphabet and all Arabic numerals, leading to 36 different characters, and the random character string is 10 characters long, the number of possible combinations is 3.66×10¹⁵. That number drops to 4.21×10¹⁴, once, for example, 5 vowels and 2 digits are removed. The number of combinations can be increased if an 11^{th} character is added. Using 29 characters to generate an 11 character string results in 1.22×10¹⁶ combinations of promotional codes.

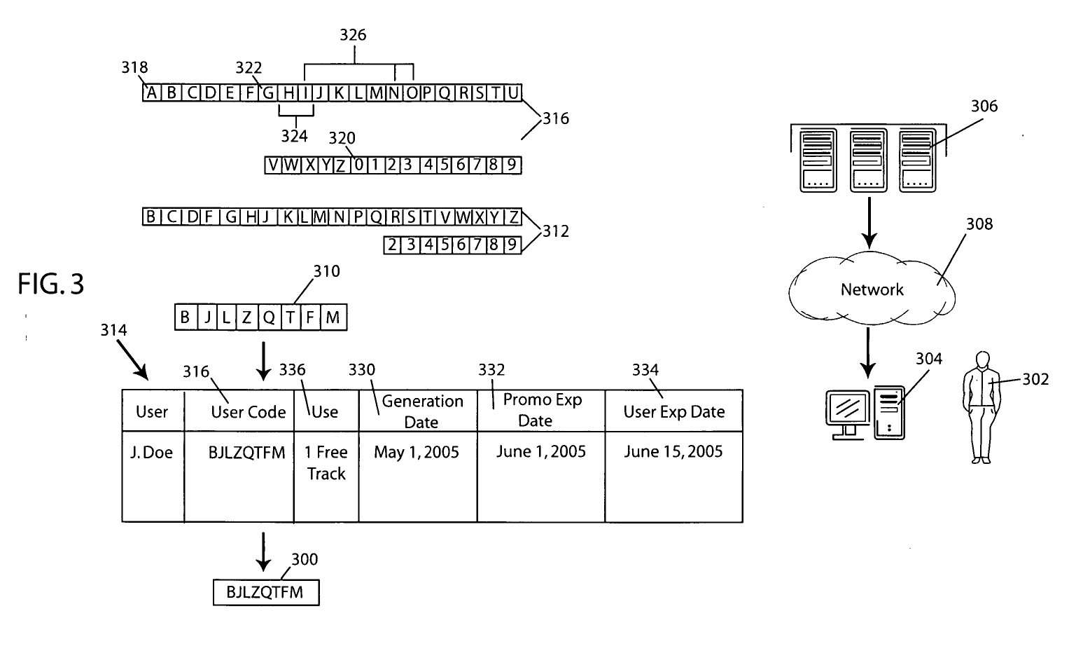

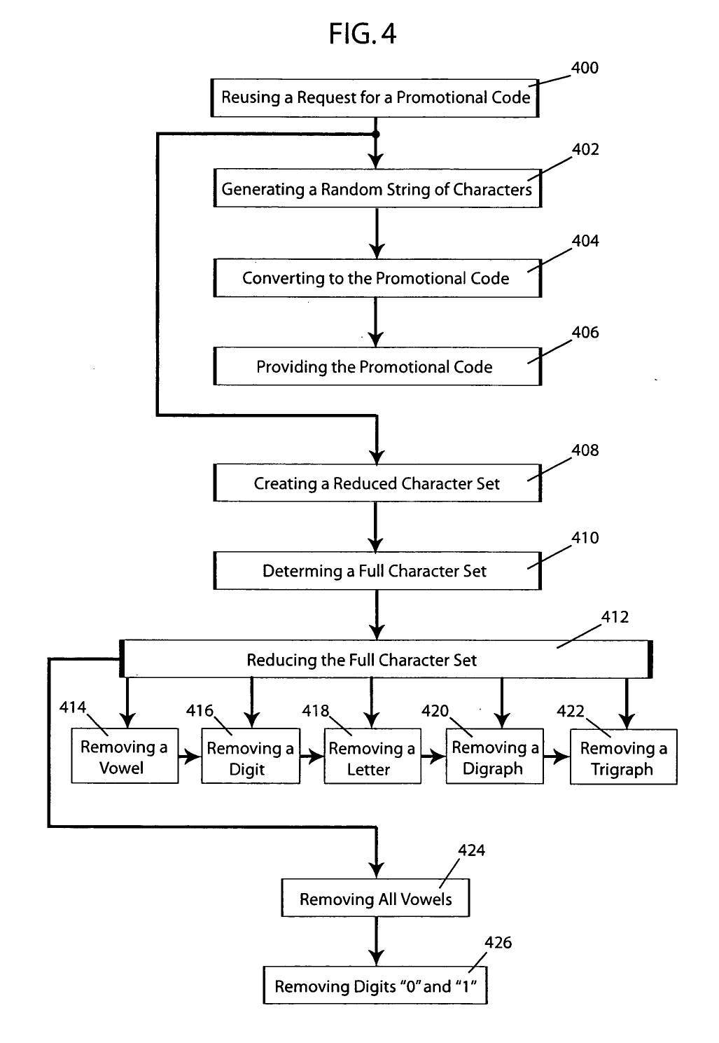

FIGS. 3 and 4 illustrate the system and method of another embodiment of the invention. The embodiment is a method for generating a promotional code 300 which includes the steps of receiving a request from a user 302 for the promotional code 300 (step 400). The user 302 is typically on a user device 304, which can be a computer, PDA, cellular telephone, or any other networked device, networked to a provider's system 306, e.g., a server. The network 308 can be a LAN, WAN, Internet or a cellular telephone network. The provider's system 306 can generate a random string of characters 310 using a reduced character set 312 (step 402). The generation of a random string of characters and a reduced character set is described in detail above.

The random string of characters 310 can be converted to the promotional code 300 (step 404) and provided to the user 302 (step 406). Converting the random string of characters 310 to the promotional code 300 can include saving the random string of characters 310 to a database 314 that can save and track information necessary to complete a commercial transaction with the promotional code 300. This information can include the identification of the user 302, the promotional code 300 and the code's use 336, e.g., one free item or a 20% discount. Further, if the promotional code is used as a user name and password, the database 314 can keep track of rights and privileges associated with the account, including expiration dates and any fixed parameters of the account, e.g., only 10 free items, access only 1 hour per day, or one free week.

In another embodiment, the user device 304 can run a client system for the provider's system 306. The client can generate the random string of characters 310 and pass the string 310 to the provider's system 306, over the network 308, and the provider's system convert the string 310 to the promotional code 300.

In a further embodiment, generating a promotional code can include the step of creating the reduced character set 312 (step 408), having the steps of determining a full character set 316 (step 410) and reducing the full character set 316 to the reduced character set 312 (step 412). Reducing the full character set 316 to the reduced character set 312 can include the same steps as above. The steps can include removing at least one vowel 318 from the full character set 316 (step 414) or removing at least one digit 320 from the full character set 316 (step 416). Further options include removing at least one letter 322 from the full character 316 set based on frequency of use of the letter 322 in a language based on the full character set 316 (step 418), removing at least one digraph 324 from the full character set 316 (step 420) and removing at least one trigraph 326 from the full character set 316 (step 422).

Furthermore, an embodiment includes using the English alphabet and Arabic numeral system and removing all vowels 318 from the full character set 316 (step 424) and removing at least one digit 320 from the full character set 316 (step 426) wherein the at least one digit is “0” and “1”.

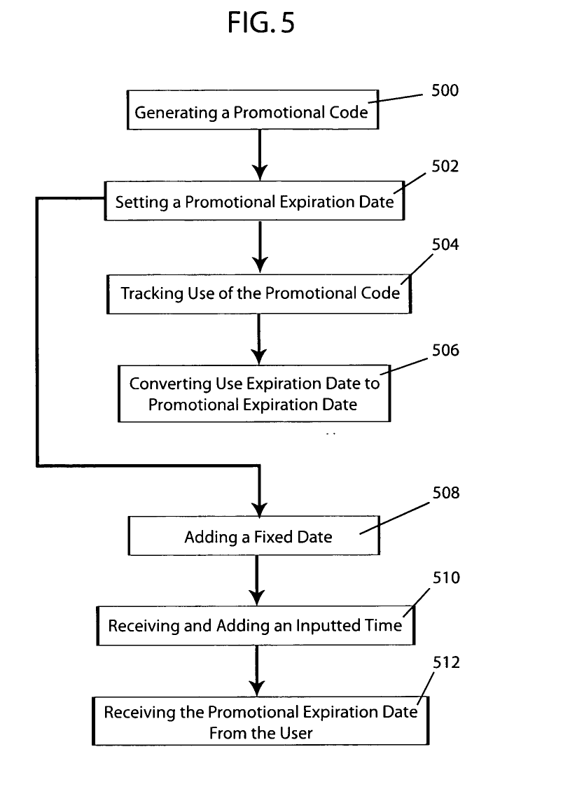

Referring now to FIG. 5, another method of the present invention is illustrated. The promotional code 300 is generated at a generation date 330 (step 500). Any method can be used to generate the promotional code, including the methods described above and any method known in the art. A promotional expiration date 332 for the promotional code 300 is set (step 502) and a use of the promotional code 300 is tracked (step 504). The use can have a related use expiration date 334. The provider's system 306 converts the use expiration date 334 to the promotional expiration date 332 (step 506).

In an example for the above embodiment, the use of promotional code 300 may include having a complimentary account or access to certain electronic content. The provider's system 306 may set the use expiration date 334 of a typical account based on the date of use. The provider may want the use of the promotional code 300 to expire on the date the promotional code 300 expires and not on the use expiration date 334. For example, the user 302 receives a promotional code 300 for a complimentary account for 1 free month. The promotional code generation date 330 is May 1, 2005 and the promotional expiration date 332 is Jun. 1, 2005. If the user 302 opens his free account by redeeming the promotional code 300 on May 15, 2005, the provider's system may give user 302 the standard account length of 1 month and set the use expiration date 334 to Jun. 15, 2005. However, the provider wants the promotion to expire on Jun. 1, 2005, so the use expiration date must be changed to the promotional expiration date of Jun. 1, 2005.

Further, the promotional expiration date 332 can be set by adding a fixed time to the generation date 330 (step 508). Alternately, the provider's system 306 can receive an inputted time and add the inputted time to the generation date 330 (step 510). Also, the promotional expiration date 332 can be received from the user 302 (step 512).

Examples of the above embodiments can include the provider's system 306 automatically adding 30 days to the generation date 330 to set the promotional expiration date 332. Alternately, the time can change depending on the type of promotional code 300 requested by user 302 and the inputted selection determines the amount of time to be added to the generation date 330. Also, the promotional expiration date 332 can be received directly from the user 302 as part of a promotional code request procedure and the date is dropped directly into the database 314. The cost of the promotional code can be altered based on the promotional expiration date 332. Thus, the longer the user 302 has for the promotion, the cost can increase. For example, if the user 302 purchases a gift card for additional account time.

While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

I claim:

1. A method for generating a random string of characters, comprising the steps of:
determining a full character set;
reducing the full character set to a reduced character set; and
generating a random string of characters using the reduced character set.

2. The method of claim 1, wherein the reducing steps comprises at least one of the steps of:
removing at least one vowel from the full character set;
removing at least one digit from the full character set;
removing at least one letter from the full character set based on frequency of use of the letter in a language based on the full character set;
removing at least one digraph from the full character set; and
removing at least one trigraph from the full character set.

3. The method of claim 1, wherein the reducing step comprises the steps of:
removing all vowels from the full character set; and
removing at least one digit from the full character set.

4. The method of claim 3 wherein the at least one digit is “0” and “1”.

5. A method for generating a promotional code, comprising the steps of:
receiving a request from a user for the promotional code;
generating a random string of characters using a reduced character set;
converting the random string of characters to the promotional code; and
providing the promotional code to the user.

6. The method of claim 5, further comprising the step of creating the reduced character set, comprising the steps of:
determining a full character set; and
reducing the full character set to the reduced character set by at least one of the steps of:
removing at least one vowel from the full character set;
removing at least one digit from the full character set;
removing at least one letter from the full character set based on frequency of use of the letter in a language based on the full character set;
removing at least one digraph from the full character set; and
removing at least one trigraph from the full character set.

7. The method of claim 5, further comprising the step of creating the reduced character set, comprising the steps of:
determining a full character set; and
reducing the full character set to the reduced character set by at least one of the steps of:
removing all vowels from the full character set; and
removing at least one digit from the full character set.

8. The method of claim 7 wherein the at least one digit is “0” and “1”.

9. A method to set promotional code expiration, comprising the steps of:
generating a promotional code at a generation date;
setting a promotional expiration date for the promotional code;
tracking a use of the promotional code having a use expiration date; and
converting the use expiration date to the promotional expiration date.

10. The method of claim 9, wherein the setting step comprises at least one of:
adding a fixed time to the generation date;
receiving an inputted time and adding the inputted time to the generation date; and
receiving the promotional expiration date from the user.
